(19) United States
(12) Patent Application Publication
(10) Pub. No.: US 2007/0299910 A1
(43) Pub. Date: Dec. 27, 2007

(54) Electronic client data acquisition and analysis system

(76) Inventors: Craig Fontenot, Tigard, OR (US); Daniel J. Veloce, Gainesville, VA (US)

Correspondence Address: Reed Smith LLP, 2500 One Liberty Place, 1650 Market Street, Philadelphia, PA, 19103-7301, US

(21) Appl. No.: 11/474,094

(22) Filed: Jun. 23, 2006

(51) Int. Cl. G06F 15/16

(52) U.S. Cl. 709/204

(57) ABSTRACT

A medical data acquisition and analysis system is disclosed. The medical data acquisition and analysis system includes a algorithm engine that receives a plurality of content, and that generates enhanced diagnosis content therefrom, a plurality of inputs to the algorithm engine, wherein each of the plurality of inputs receives content from a respective one of a plurality of collaborators seeking to generate the enhanced diagnosis content, at least one algorithm resident at the algorithm engine, wherein the enhanced diagnosis content is generated in accordance with the at least one algorithm, at least one output from the algorithm engine, wherein the enhanced diagnosis content is output via the at least one output to enable a system user to provide enhanced diagnosis content.

### FIELD OF THE INVENTION

The present invention relates to data acquisition and analysis systems, particularly to such systems that analyze input data and generate output data using an adaptive algorithm system.

### BACKGROUND OF THE INVENTION

Data intake questionnaires are well known and are used throughout the world to assist professionals who serve various types of clients. Questionnaires are used by many types of professionals, including, but not limited to, medical doctors, social scientists, employers, and security screeners. Data intake is also performed for purposes of personal health monitoring (e.g., blood pressure, blood sugar level, temperature). Data intake is also necessary to control various types of automated and semi-automated control systems, including, but not limited to, vehicle systems (e.g., in automobiles, motorcycles, trains, airplanes, space vehicles), building systems (e.g., for security, climate control), and private residence systems (e.g., lighting, music, lawn watering, security, climate control).

One limitation of standard data acquisition systems is that they are used primarily to create a historical record, and perhaps to guide a single set of decisions. This naturally limits the ability of a professional or computer system to effectively diagnose a problem or to control a system over time using this input information.

Thus, a need exists for a data acquisition and analysis system that captures information electronically, compares it with data already acquired from either the same or other clients, and uses the data to solve problems or control a system over time. Also, a need exists for a data acquisition and analysis system that presents targeted advertisements to clients and professionals, based on a user's input to the data acquisition and analysis system.

### SUMMARY OF THE INVENTION

The present invention is directed to a medical data acquisition and analysis system that includes a algorithm engine that receives a plurality of content, and that generates enhanced diagnosis content therefrom, a plurality of inputs to the algorithm engine, wherein each of the plurality of inputs receives content from a respective one of a plurality of collaborators seeking to generate the enhanced diagnosis content, at least one algorithm resident at the algorithm engine, wherein the enhanced diagnosis content is generated in accordance with the at least one algorithm, at least one output from the algorithm engine, wherein the enhanced diagnosis content is output via the at least one output to enable a system user to provide enhanced diagnosis content.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates a block diagram of the electronic client data acquisition and analysis system according to an aspect of the present invention;

FIG. 2 illustrates a communication flow diagram of the electronic client data acquisition and analysis system according to an aspect of the present invention;

FIG. 3a illustrates a coordinate basis as determined by vector analysis of entire dataset modeled together, according to an aspect of the present invention;

FIG. 3b illustrates a T² line plot according to an aspect of the present invention;

FIG. 4a illustrates a machine learning node optimization and variables of importance identification according to an aspect of the present invention;

FIG. 4b illustrates relative class strength for ADEN, COID, NORMAL, SCLS, and SQUA according to an aspect of the present invention;

FIG. 5a illustrates a T² line plot of cancer subsets run against NORMAL model according to an aspect of the present invention;

FIG. 5b illustrates a fit to model (SPE in this example) according to an aspect of the present invention;

FIG. 6a illustrates class=ADEN membership probability distributions of cancer subset gene vectors belonging to normal subset according to an aspect of the present invention;

FIG. 6b illustrates class=COID membership probability distributions of cancer subset gene vectors belonging to normal subset according to an aspect of the present invention;

FIG. 6c illustrates class=SCLC membership probability distributions of cancer subset gene vectors belonging to normal subset according to an aspect of the present invention;

FIG. 6d illustrates class=SQUA membership probability distributions of cancer subset gene vectors belonging to normal subset according to an aspect of the present invention;

FIG. 7 illustrates a vector machine algorithm 2 results for NORMAL vs. PROSTATE TUMOR classes according to an aspect of the present invention;

FIG. 8a illustrates example waveforms (temporally-paired waveforms) according to an aspect of the present invention;

FIG. 8b illustrates temporal pattern co-evolution of: three ECG leads, arterial pressure, pulmonary arterial pressure, respiratory impedance, and airway CO2 waveforms according to an aspect of the present invention; and

FIG. 8c illustrates key variable contribution to temporal pattern change seen in FIG. 7b according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical data acquisition and analysis systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

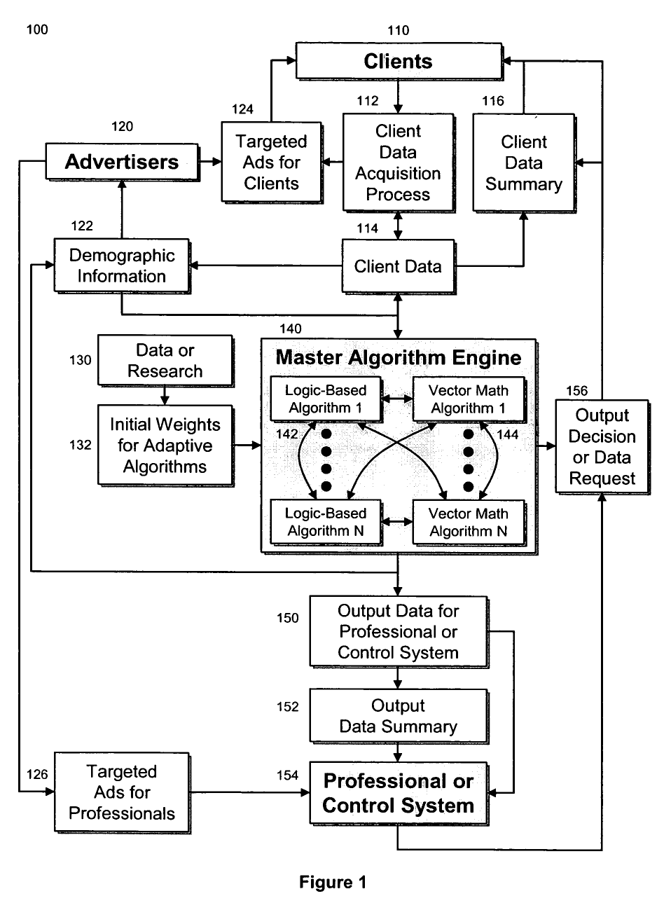

Referring now to FIG. 1, there is shown a block diagram of the electronic client data acquisition and analysis system according to an aspect of the present invention. As may be seen in FIG. 1, analysis system 100 may include a plurality of clients 110, a client data acquisition process 112, a client data 114, a client data summary 116, a plurality of advertisers 120, a demographic information 122, a plurality of targeted ads for clients 124, a plurality of targeted ads for professionals 126, a data or research 130, an initial weights for adaptive algorithms 132, a master algorithm engine 140, a plurality of logic-based algorithms 142, a plurality of vector math algorithms 144, an output data for professional or control system 150, an output data summary 152, a professional or control system 154, and an output decision or data request 156.

Clients 110 may provide data via client data acquisition process 112, which may produce client data 114, which in turn may produce client data summary 116 (provided to clients 110) and demographic information 122 (provided to advertisers 120). Advertisers 120 may provide targeted ads for clients 124 to be viewed by clients 110 during client data acquisition process 112, and/or at client data summary 116. Advertisers 120 may also provide targeted ads for professionals 126 to be viewed by a plurality of professionals or control systems 154 during viewing of output data for professional or control system 150 or output data summary 152. Data or research 130 may determine initial weights for adaptive algorithms 132. Master algorithm engine 140 may receive input from client data 114 and initial weights for adaptive algorithms 134, and/or rules or initial conditions for algorithms 142 and/or 144. Master algorithm engine 140 may be comprised of a plurality of logic-based algorithms 142 and a plurality of vector math algorithms 144. Master algorithm engine 140 may provide output data for professional or control system 150, which may in turn provide output data summary 152, which may in turn be provided to professionals or control systems 154. Professionals or control systems 154 may use output data for professional or control system 150 and output data summary 152 to make a plurality of output decisions or data requests 156, which in turn may be administered to clients 110.

Clients 110 may be of any type, including, but not limited to, medical patients (e.g., for uses in places including, but not limited to, hospitals, doctor's offices, ambulances, and at-home patient monitoring), real estate buyers or sellers, subjects of demographic studies (e.g., social sciences, economic behavior, group dynamics), potential employees, and travelers who need to undergo security screens. Clients 110 may be people, computer systems, medical diagnostic devices, other analysis algorithm systems, or anything that would benefit from the use of a data acquisition and analysis system that may be known to those possessing an ordinary skill in the pertinent art. Clients 110 may be people or entities that use automated or semi-automated control systems, which can be of any type, including, but not limited to, vehicle systems (e.g., in automobiles, motorcycles, trains, airplanes, space vehicles), building systems (e.g., for security, climate control), and private residence systems (e.g., lighting, music, lawn watering, security, climate control). In a fully automated control system, clients 110 may be the control system or control system CPU itself. In an aspect of the present invention, client 110 may be an automobile, which may acquire alertness data from the driver. If the automobile driver's alertness drops below a pre-defined level, the automobile may alert the driver to pull over to the side of the road to rest until alertness increases.

Client data acquisition process 112 may be of any type, including, but not limited to, typing on a keyboard connected to a personal computer, typing on a keyboard of a self-contained input computer system, tapping on a touch-screen input device with a client 110's fingers or a stylus, client 110 speaking the information into a microphone or headset, input via an implantable device, input via a hand-held or tablet computer, input via a biomedical device (e.g., heart monitor), or input via any other method known to those possessing an ordinary skill in the pertinent art. Client data acquisition process 112 may be performed at the place of business or residence of the professional or control system (e.g., via a personal computer or via a mobile, portable unit), or it may be performed remotely, via the internet (e.g., form-entry on a website (HTTP-based), e-mail submission, running a specific input software program remotely). Client data acquisition process 112 may be performed via add-on toolboxes or suites which are modules that are customized for particular applications (ER, PCP, GI, etc.). Client data acquisition process 112 may also be done in an automated fashion, in a way including, but not limited to, RFID (radio frequency input device) output from a blue-tooth enabled thermometer, blood-pressure taking device, heart monitor, blood-sugar analysis device, sleep mask for brain waves, respiratory probe, implantable device, or other diagnostic device. Client data acquisition process 112 may also be done via other data acquisition tools, including, but not limited to, vehicular sensors (e.g., for speed, engine R.P.M., altitude, fuel remaining), appliance monitors (for home or industrial appliances), or motion detection sensors (for home or industrial security systems).

Client data acquisition process 112 may be in response to static questions or requests for a few pieces of data, or it may be adaptive, whereby new questions are presented to client 110 based on the responses given during client data acquisition process 112, using a pre-learned rule set and/or an adaptively-learned rule set. Client data acquisition process 112 may be in response to questions, and it may be in response to other prompts for client 110, including, but not limited to photographs, illustrations, or other means or eliciting information or a preference that are known to those possessing an ordinary skill in the pertinent art. Client data acquisition process 112 may also be in the form of receiving data from an electronic or mechanical device, including, but not limited to, a heart monitor, blood pressure monitor, an automobile engine (e.g., for fault detection), or any other device.

According to an aspect of the present invention, a professional or control system 154 may prepare a list of questions, photographs, images, or other data requests in advance of client data acquisition process 112. The list of data that are desired to be elicited from client 110 may vary, whereby client data acquisition process 112 presents a different list of questions, depending upon some characteristic of client 110 (e.g., age, gender, model of vehicle), or it may vary the data requests adaptively during client data acquisition process 112. According to an aspect of the present invention, a professional or control system 154 may prepare a list of more probing questions or data requests for client 110, to be presented to client 110 based on the response received to each initially-prepared question, thereby allowing client data acquisition process 112 to function in an adaptive manner. For example, if client 110 reveals during client data acquisition process 112 that he or she has a history of heart disease among his or her progenitors, additional questions or data requests may be presented to client 110 which ask which progenitors had the condition, and at what age range each progenitor had the condition. On the other hand, if client 110 reveals that he or she does not have a family history of heart disease, client data acquisition process 112 may accept the negative response and may therefore not present the additional questions or data requests. The list of more probing questions that allow data acquisition process 112 to function in an adaptive manner may be on any subject (e.g., medical-related, vehicle diagnostic-related, climate control related), and they may be in a multiple-hierarchy style, whereby an answer to an initially-prepared question causes a list of more probing questions to be presented to client 110, and the answer to each of the more probing questions may cause further probing questions to be presented to client 110.

Client data acquisition process 112 may include static graphical choices in addition to, or instead of static questions or data requests, or it may be adaptive, whereby new graphical choices and/or questions are presented to client 110 based on the responses given during client data acquisition process 112. According to an aspect of the present invention, a professional or control system 154 (e.g., a real estate agent) may prepare a list of questions and/or photographs and/or graphical depictions of homes and/or aspects of homes in advance of client data acquisition process 112. A client 110 may be presented with a questionnaire during client data acquisition process 112, including one or more questions and/or photographs and/or graphical depictions of homes and/or aspects of homes. Based on the responses of client 110 during client data acquisition process 112, which may indicate the preferences of client 110, the client may be presented with different potential homes to view, and the client may be presented with different targeted ads for clients 124. According to another aspect of the present invention, client data acquisition process 112 may request that client 110 click (with a computer mouse or other input device) on part of a picture, play or stop part of a video, or click on a type of person that is liked or disliked.

Client data acquisition process 112 may also include interactive data requests or graphical choices. According to an aspect of the present invention, client data acquisition process 112 may determine what amount of time client 110 takes to respond to certain questions or data requests. Master algorithm engine 140 may use the amount of time as an input to determine information about client 110 regarding the question or data request, including, but not limited to, reading comprehension, ambivalence regarding answer choices, and ethical dilemmas concerning the question or data request. Client data acquisition process 112 may also record biometric or other observations about client 110 curing the data acquisition process, including, but not limited to, input via microphone, eye movement, brainwaves, biometric response, and heart monitor response.

Client data 114 may be the raw data that is input by client 110 through client data acquisition process 112. Client data 114 may comprise a single number (e.g., patient's temperature), a constant or intermittent stream of data over s period of time (e.g., client 110 brainwaves, thermal imaging), or it may comprise many fields of information, input by a client 110 during a plurality of client data acquisition processes 112, over a period of time. Client data 114 may be printed out on paper, or it may be stored in a variety of ways, including, but not limited to, the hard disk drive of the personal computer used for client data acquisition process 112, the hard disk drive of a self-contained input computer system, a computer server located at the place of business or residence of professional or control system 154, a remote computer server, a USB (universal serial bus) storage drive, a hand-held computer, or a tablet computer. Client data 114 may also be stored via other methods known to those possessing an ordinary skill in the pertinent art.

According to an aspect of the present invention, client data 114 may be stored in a relational database which may catalogue all information received. This database may be designed in modules which may accommodate future expansion (e.g., including more client data acquisition processes 112 or a plurality of types of clients 110). All data records may fit within the database in discrete tables according to database organization rules, which will vary, depending on the type of clients 110 or professional or control systems 154 that are using the system. Most generic information (e.g., that which is common to many clients 110 or professional or control systems 154) may be stored in a central database module, and most unique information (e.g. that which applies to few clients 110 or professional or control systems 154) may be stored in application-specific database modules.

According to an aspect of the present invention, the data storage and transfer system for client data 114 and output data for professional or control system 150 may employ standard data security methods to ensure data and system integrity, confidentiality, and authenticity. The security methods used may include, but are not limited to, software based network traffic firewalls, encrypted communications (e.g., BlueTooth, SSL, IPSec, VPN), encrypted stored data, and dual factor authentication.

Client data summary 116 may be a summary of the raw data that is input by client 110 through client data acquisition process 112. Professional or control system 154 may designate in advance which client 110 responses will be included in client data summary 116, or client data summary 116 may be fully customizable (e.g., the user selects which questions are included) by professional or control system 154 or by client 110. According to an aspect of the present invention, professional or control system 154 or client 110 may use the internet to log into a remote server that contains intake questionnaire data, and professional or control system 154 or client 110 may select individual questions or groups of questions to be presented in client data summary 116. Client data summary 116 may also be used by client 110 to verify that answers provided during client data acquisition process 112 were input correctly and accurately. A plurality of client data summary 116 for each client 110 may be stored on the personal computer hard drive of client 110, on the personal computer hard drive of professional or control system 154, on a remote server, or via other methods known to those possessing an ordinary skill in the pertinent art.

Advertisers 120 may be of any type, including, but not limited to, pharmaceutical companies, medical supply companies, automobile parts suppliers, home improvement contractors, or any other company who desires to reach an audience of clients 110 or professionals or control systems 154.

Demographic information 122 may be taken from the information obtained from clients 110 during client data acquisition process 112. Demographic information 122 may be stripped of any information that would identify a specific client 110. In aspects of the present invention, demographic information 122 may comprise what percentage or number of clients 110 gave a particular answer to a question during client data acquisition process 112, or it may comprise how many times targeted ads for clients 124 were shown to clients 110, or it may comprise how many times targeted ads for professionals 126 were shown to professionals or control systems 154. Demographic information 122 may be used by advertisers 120 to determine what types of ads may be designed for specific targeting to clients 110, based on the client data acquisition process 112 responses. Demographic information 122 may also be used to determine how much money advertisers should pay to reach clients 110 via targeted ads for clients 124 or to reach professionals or control systems 154 via targeted ads for professionals 126.

According to an aspect of the present invention, targeted ads for clients 124 may be shown to clients 110 during client data acquisition process 112. In one embodiment of the present invention, client data input process is via a keyboard connected to a personal computer, and depending on the answer a particular client 110 submits for a particular question or plurality of questions, targeted ads for clients 124 would be shown to that specific client 110. Targeted ads for clients 124 may be fixed graphical displays, or they may be clickable links, which may take a client 110 to the websites of advertisers 120 for additional product or service information.

According to an aspect of the present invention, targeted ads for professionals 126 may be shown to professionals or control systems 154 during viewing of output data for professional or control system 150 or output data summary 152. The targeted ads for professionals 126 may be targeted to specific professionals or control systems 154 in numerous ways, including, but not limited to, being based on the customization of output data summary 152, or based on demographic information 122.

Data or research 130 may provide data to establish initial weights for adaptive algorithms 132. These initial weights for adaptive algorithms 132 are used by the master algorithm engine 140. Data or research 130 may provide data of various types, including, but not limited to, scientific (cancer research), societal (population research), and mechanical (automobile engine performance research). The data generated may include, but is not limited to, continuous, categorical, nominal, and ordinal. Examples of sources of data or research 130 may include, but is not limited to, biological and environmental laboratory results, clinical results, MRI output, patient-reported symptoms or feelings, blood-pressure, atmospheric pressure, weather data, economic indicators, stock market performance, stress index scores, biosensor data, patient history, genetic analysis, and other qualitative research.

Initial weights for adaptive algorithms 132 may be culled from data or research 130. These initial weights for adaptive algorithms 132 may be specifically extracted from data or research 130 in the specific areas of interest of professionals or control systems 154. For example, according to an aspect of the present invention, a doctor may want to obtain initial weights 132 related to cholesterol, age, gender, and body-mass index (BMI) (culled from heart disease research 130), to input into a master algorithm engine 140, to receive output data 150 that will give the doctor a health score index (HSI), which the doctor may use to make an output decision or data request 156. Initial weights for adaptive algorithms 132 provide an input into the logic-based algorithms 142 and vector math algorithms 144 that comprise the master algorithm engine 140. These weights 132 give master algorithm engine 140 a starting point from which it can adapt itself to find the optimal relationships between the algorithm variables. Initial weights for adaptive algorithms 132 may be changed, once master algorithm engine 140 begins running. According to an aspect of the present invention, the change or rate of change of these weights may be a separate input to be used by algorithm engine 140.

According to an aspect of the present invention, initial weights for adaptive algorithms 132 may be all set to a zero value, which would remove them from analysis system 100. The use of initial weights for adaptive algorithms 132 as an input to master algorithm engine 140 is optional. According to another aspect of the present invention, master algorithm engine 140 may have its initial state set via a set of rules, unrelated to data or research 130.

Master algorithm engine 140 may have several inputs, including, but not limited to, initial weights for adaptive algorithms 132, client data 114, demographic information 122, all raw data from client 110, previous data requests given to client 110, as well as other data that may be known to those possessing an ordinary skill in the pertinent art. Master algorithm engine 140 may feed these inputs into each of the logic-based algorithms 142 and each of the vector math algorithms 144. Master algorithm engine 140 may receive output from each of the algorithms 142 and 144 and combine the output into a single overall measure (e.g., health score index (HSI)), or it may combine the output into a plurality of overall measures. According to an aspect of the present invention, algorithms 142 and 144 may provide inputs and outputs to each other, working in parallel and/or working in series. There may also be a plurality of master algorithm engines 140, and the output of one engine 140 may provide input to another engine 140, or they may work in series or parallel, providing inputs and outputs to each other.

According to an aspect of the present invention, master algorithm engine 140 may include multivariate trajectory analysis. One embodiment of the invention, using multivariate trajectory analysis, is a method of determining a multivariate health score index (HSI). This method may be employed to classify/type (or subtype) an observation vector, and then determine and track velocity and acceleration vectors (through repeated measurements at known time intervals). This temporal domain and associated vectors may yield important information which may be critical in determining various outputs, including, but not limited to, prognosis, treatment effectiveness, and treatment progress. This analysis may be used as an output for HSI trajectory tracking and visualization, but it may also be used as an input in a subsequent analysis (using HSI velocity and acceleration as inputs). Also, this analysis may be used to find and leverage trends in the data to identify different relationships, types, or sub-types, and/or how they change with time. When assessed independently, each variable may be observed to be within an agreeable standard deviation, but when assessed together, outliers or different groupings or swarms may be detectable. The output of this analysis may be visualized in various mediums and in various dimensions that are known to those possessing an ordinary skill in the pertinent art.

According to an aspect of the present invention, master algorithm engine 140 may include biological monitoring, biological process monitoring, fault detection, geography, stock market trends, a health score index, or any other data that needs to be monitored that is known to those possessing an ordinary skill in the pertinent art. In one embodiment of the invention, master algorithm 140 may be used to assess, classify, track and monitor a multivariate score over time using an adaptive model, which may compensate for a lack of complete system or variable knowledge and/or missing variables in an input vector. High-order datasets (those that include many variables) may be modeled and have the output reduced to include only important variables and/or variable interactions. The output may be further visually simplified to three charts (although fewer than three or more than three charts may also be used), each a function of the previously mentioned model and of time. These charts may include, but are not limited to, the standard deviation of the sample vector based on the model, the fit of the sample vector to the model, and the adaptive model limits for the other two charts.

According to an aspect of the present invention, master algorithm engine 140 may include time as a variable. Depending on the type of analysis, time may be used in various ways, including but not limited to, a batch variable (where similar matrixes are stacked in a new time dimension), and a column vector. In one embodiment of the invention, time series data may be used, which offers the ability to track data trends. Time may be an important variable for mathematical and physical reasons. For example, the thermodynamic state of Entropy may be defined in terms of the direction of the time vector. Time is relevant in the discussion of Gibbs Free Energy, non-state functions, and path dependent functions, all of which are important for analysis of biological systems. Time also allows us to calculate determination of velocity and acceleration. For velocity, we employ the operator del:

$$∇ = ( \frac{\partial }{\partial x} , \frac{\partial }{\partial y} , \frac{\partial }{\partial z} ) ,$$

which, when operated on the function p in Cartesian coordinates as an example, results in the expression:

$$∇ p = ( \frac{\partial p}{\partial x} , \frac{\partial p}{\partial y} , \frac{\partial p}{\partial z} ) .$$

For acceleration, using Cartesian coordinates again, we employ the LaPlacian operator:

$${∇}^{2} = ∇ \cdot ∇ = \frac{{\partial }^{2}}{\partial {x}^{2}} + \frac{{\partial }^{2}}{\partial {y}^{2}} + \frac{{\partial }^{2}}{\partial {z}^{2}} .$$

### These examples of vector calculus operations may be expressed in Cartesian coordinates for simplicity, but they may also be expressed in terms of any orthogonal coordinate system (conventional), or any other coordinate system (non-conventional).

Logic-based algorithms 142 and vector math algorithms 144 may contain or be derived from methods known to those possessing an ordinary skill in the pertinent art and may result from some or all combinations, including, but not limited to, linear algebra, calculus, genetic algorithms, scientific laws, empirically derived boundary conditions, artificial constraints, transforms and filters (e.g., Fourier, LaPlace, wavelets). These are hereby referred to as mixed-type models (MTM).

Logic-based algorithms 142 and vector math algorithms 144 may be adaptive and include both supervised and/or unsupervised learning. Additionally, data from various sources (e.g., cancer research, population research, automobile engine research, biological and environmental laboratory results, clinical results, MRI output, patient-reported symptoms or feelings, blood-pressure, atmospheric pressure, weather data, economic indicators, stock market performance, stress index scores, biosensor data, patient history, genetic analysis, and other qualitative research, etc.) can be used as data or research 130 to input to algorithms 142 and 144 to help elucidate interactions, and/or dependent variable modulation. The model may be configured so that we ‘learn as we go’, or we learn as we change inputs. It is a dynamic process.

Logic-based algorithms 142 and vector math algorithms 144 may use one or more of the following in its calculations: independent variables only, dependent or system output variables only, independent variables with single dependent or system output variable, independent variables with multiple dependent or system output variables, hierarchical, and mixed type. Independent variables, or transformations thereof, are those which may come from external initial weights 132, and dependent variables may be derived by combining or performing mathematical operations on the independent variables. The variables may include various data-type categories, including, but not limited to, continuous, semi-continuous, categorical, nominal, and ordinal, and others known to those possessing an ordinary skill in the pertinent art.

According to an aspect of the present invention, incorporating large datasets 130 into the master algorithm engine 140 (via initial weights for adaptive algorithms 132), may allow populations and subpopulations of similar structure to determined, and different treatments may be evaluated to define the allowable return to health (RtH) hyperpath. According to another aspect of the present invention, the vector basis space used may be non-predetermined but is a variable. The vector basis space used may be determined using training data; then test data may run against that model. A mixed model (part predetermined basis space and part un-predetermined basis space) may be employed. The changes in the model over time may be tracked and analyzed, because potentially useful data may be discovered (e.g., changes in the environment driving changes in the model, disease progression, etc.)

According to an aspect of the present invention, a higher-level master algorithm engine 140 may try different variations of various models so that genetic algorithms (Al) govern over all model development, so that the best combinations are kept (e.g., linear algebra in one algorithm 142 or 144, physical modeling in another algorithm 142 or 144, use those model outputs as inputs for an Al model master algorithm engine 140). Also, the master algorithm engine 140 may vary different combinations of model optimization parameters, including, but not limited to, ‘lag’ and data filters (and optimization parameters of those). A master algorithm engine 140 might also be used to determine natural groupings in the data. Once identified, the master algorithm 140 may perform subsequent analysis such as vector machine. In addition, ‘Batch or Phase’ analysis may be used by master algorithm engine 140, wherein matrixes of similar input and structure can be stacked into an additional dimension and analyzed by utilizing this new dimension.

According to an aspect of the present invention, a higher-level master algorithm engine 140 may use logic-based algorithms 142 and vector math algorithms 144 to determine relationships between the input variables or variables created from combinations of these input variables. Master algorithm engine 140 may also determine key combinations of variables that may be driving the difference between one data set (e.g., cancerous sample) and another data set (e.g., non-cancerous sample). Master algorithm engine 140 may also determine if delineations are present in the data, it may compare output variables of one data set against other data sets, and it may compare results over time using one or more of the data analysis methods described above, or using other data analysis methods known to those possessing an ordinary skill in the pertinent art. According to another aspect of the present invention, master algorithm engine 140 may employ a survival-of-the-fittest type scheme to achieve optimal results from algorithms 142 and 144. In complex multivariate analysis with multiple algorithms, local minima and maxima may be present, which may result in different outputs from different algorithms that use the same input data. To improve performance in this situation, master algorithm 140 may compare and contrast the intermediate and final results from algorithms 142 and 144, and it may choose the best results or best combinations of results. Algorithms 142 and 144 may also help each other learn and produce more optimal results. Master algorithm engine 140 may obtain intermediate results from algorithms 142 and 144 to try to find unstable nodes in the analysis. Master algorithm 140 may assess the strengths and/or weaknesses of individual algorithms, and it may use the outputs from the strongest performing algorithms.

Output data for professional or control system 150 may be produced as a result of the calculations within master algorithm engine 140 for each client 110. The output data 150 may be a single number representing a single result (e.g., patient temperature), a single response (e.g., yes/no), a continuous stream of results, a complex score (e.g., health score index (HSI)), or a continuous stream of scores, which combines many input data (from initial weights 132 and client data 114) to produce an output that is useful to a professional or control system 154. According to an aspect of the present invention, output data 150 may be stored in a relational database which may catalogue all information received. This database may be designed in modules which may accommodate future expansion. All data records may fit within the database in discrete tables according to database organization rules, which will vary, depending on the type of professional or control systems 154 that are using the system. According to another aspect of the present invention, output data 150 may be used to motivate a request for more data (156) from client 110.

Output data summary 152 may be a summary of the raw output data for professional or control system 150. Professional or control system 154 may designate in advance which output data 150 will be included in output data summary 152, or output data summary 152 may be fully customizable (e.g., the user selects which questions are included) by professional or control system 154. According to an aspect of the present invention, professional or control system 154 may use the internet to log into a remote server that contains output data for professional or control system 152, and professional or control system 154 may select individual data fields or groups of data to be presented in output data summary 152. A plurality of output data summaries 152 for each client 110 may be stored on the personal computer hard drive of professional or control system 154, on a remote server, or via other methods known to those possessing an ordinary skill in the pertinent art.

Professional or control system 154 may be any of a broad range of client-service professional, including, but not limited to, medical doctors, social scientists, employers, and security screeners. Professional or control system 154 may be a person, another algorithm, a set of algorithms, or a hierarchal algorithm system, or any other entity that has a need for the output data 150 that is known to those possessing an ordinary skill in the pertinent art. Professional or control system 154 may also be any of a broad range of automated and semi-automated control systems, including, but not limited to, vehicle systems (e.g., in automobiles, motorcycles, trains, airplanes, space vehicles), building systems (e.g., for security, climate control, lighting), and private residence systems (e.g., lighting, music, lawn watering, security, climate control). According to an aspect of the present invention, a professional 154 may be a doctor, who is treating patient clients 110 to diagnose and treat various conditions and illnesses (e.g., common cold, heart disease, etc.).

Output decision or data request 156 may be made by professional or control system 154 to treat or control client 110. The electronic client data acquisition and analysis system 100 may assist the professional 154 to make an optimal output decision or data request 156, using the benefit of the master algorithm engine 140, which in turn uses the information culled from a research area of data 130 and the client data acquisition process 112. According to an aspect of the present invention, a doctor 154 makes an output decision 156 to determine a treatment course and track relevant data over time to cure an illness for client 110. According to another aspect of the present invention, a climate control CPU may make an output decision 156 by increasing the flow of air to one part of a building or by opening windows in a part of a building, based on the values and rate of change of temperature and humidity input data 112 from all areas of the building.

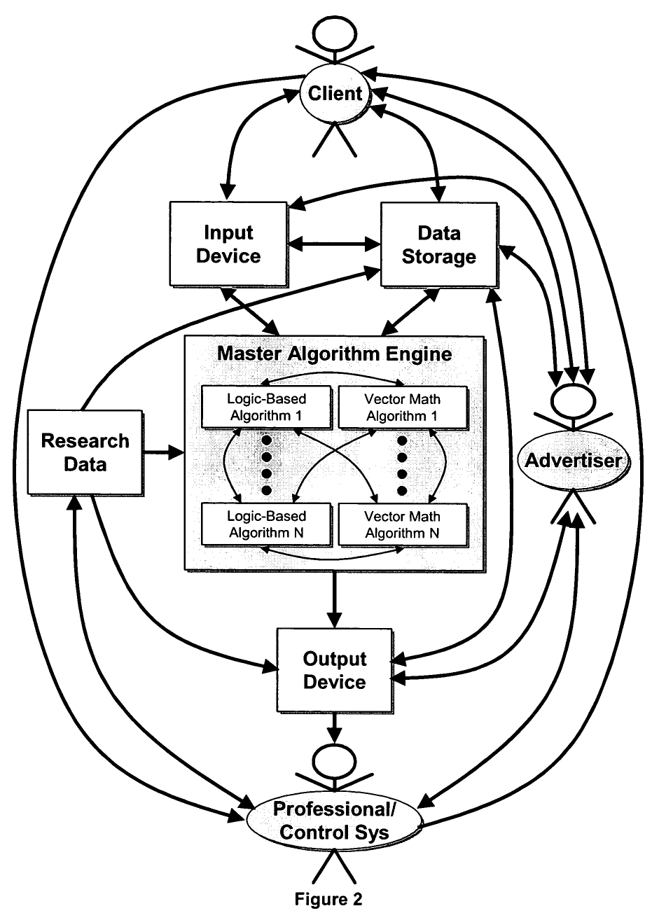

Referring now to FIG. 2, there is shown a communication flow diagram of the electronic client questionnaire analysis system according to an aspect of the present invention. As may be seen in FIG. 2, the electronic client questionnaire analysis system may contain many channels of communication between the various potential elements of the system. For example, a client may provide information to (e.g., question responses), and receive information from (e.g., additional adaptive questions and/or advertisements) the input device; a client may provide information to (e.g., choices of fields for custom client input data summary reports), and receive information from (e.g., client input data summary reports) the data storage device; a client may provide information to (e.g., demographic information), and receive information from (e.g., advertisements or special offers) an advertiser; and a client may provide information to (e.g., questions about treatment), and receive information from (e.g., treatment or control decision) a professional or control system. Also, many of the component elements of the questionnaire analysis system communicate with many other elements. For example, the Master Algorithm Engine may communicate with the input device, data storage device, the output device, and it receives input from research data. Also, the professional/control system may communicate with clients, advertisers, and he/she/it may supply or receive research data. In addition, many other combinations of communication are possible between the system elements, as shown in FIG. 2, and in various other ways.

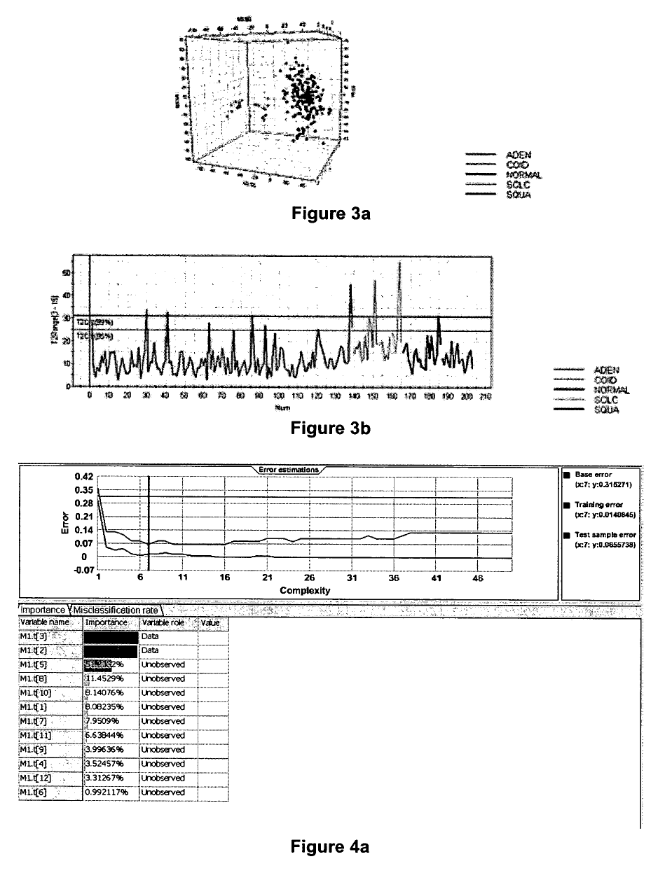

Referring now to FIG. 3a, there is shown a coordinate basis as determined by vector analysis of entire dataset modeled together, according to an aspect of the present invention. As may be seen in FIG. 3a, the Master Algorithm Engine may take a large number of variables from a sample data set and perform a vector analysis to extract the most meaningful combination of variables to provide to a professional or control system 154. In this example, Harvard Lung Cancer Data was taken from a publicly available reference (Arindam Bhattacharjee, et al. “Classification of Human Lung Carcinomas by mRNA Expression Profiling Reveals Distinct Adenocarcinoma Subclasses”. PNAS, 98(24):13790-13795, November 2001). From 203 instances of lung tumors and normal lung tissue, 12,600 gene variables were input into a vector analysis. A vector analysis was performed with all the data run together to create a global model in order to determine key combinations of variables and the output of that analysis was used as input for a basic machine learning algorithm. The output of this example might be used in many ways, including, but not limited to, diagnosis, prognosis, treatment course decisions, and determining which key gene interactions are present. FIG. 3a shows that the data can be separated using the three most meaningful combinations of the 12,600 variables; each of the five samples (adenocarcinomas (ADEN), squamous cell lung carcinomas (SQUA), pulmonary carcinoids (COID), small-cell lung carcimonas (SCLC), normal lung samples (NORMAL)) can be observed to take up a primarily different portion of three-dimensional space. This may demonstrate that some structure is present in the dataset. According to an aspect of the present invention, one vector-based and one logic-based algorithm may be used, or a vector analysis may be performed on each data sample, or the output of a vector-based algorithm may be input into a machine-learning algorithm.

Referring now to FIG. 3b, there is shown a T² line plot, according to an aspect of the present invention. As may be seen in FIG. 3b, some structure is present in the dataset. FIG. 3b shows that most of the data points shown in FIG. 3a fit the vector model (created from the combination of the 12,600 variables) relatively well.

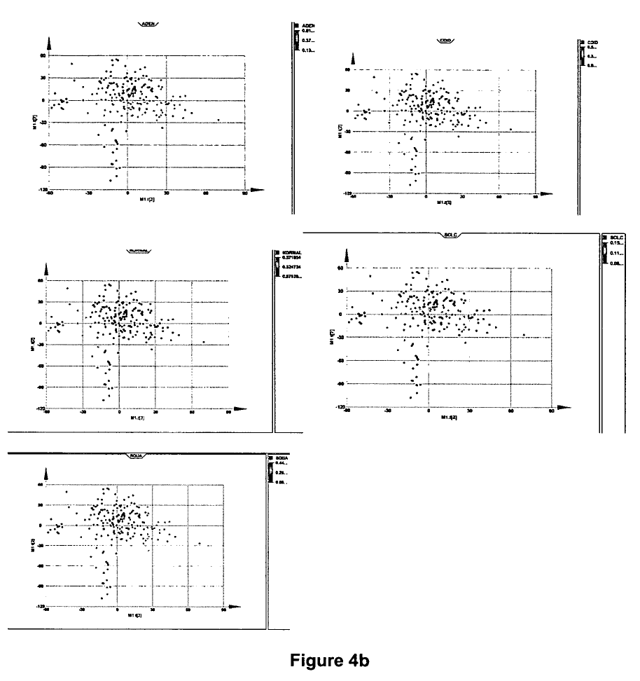

Referring now to FIG. 4a, there is shown a machine learning node optimization and variables of importance identification, according to an aspect of the present invention. As may be seen in FIG. 4a, a machine learning algorithm was used to identify which combinations of the 12,600 variables were most relevant for separating the 5 types of samples in three-dimensional space. The scores and loadings from vector machine analysis were used as input into the machine learning algorithm. In FIG. 4a, variables 3, 2, and 5 (each is a linear combination of the 12,600 variables) were most important. Also, in FIG. 4a, it can be seen that using seven combinations of variables resulted in the lowest degree of model error.

Referring now to FIG. 4b, there is shown relative class strength for ADEN, COID, NORMAL, SCLS, and SQUA, according to an aspect of the present invention. As may be seen in FIG. 4b, a two-dimensional combination of variables 2 and 3 from FIG. 4a may be used to determine the likelihood that a tissue sample belongs to each of the five known types. For example, in the ADEN chart, if variable 2 is between −30 and 0, and variable 3 is between −30 and 30, there is approximately a 60% chance that such a tissue sample belongs to the ADEN tissue group (as denoted by the lighter shading of the dots in that numerical range).

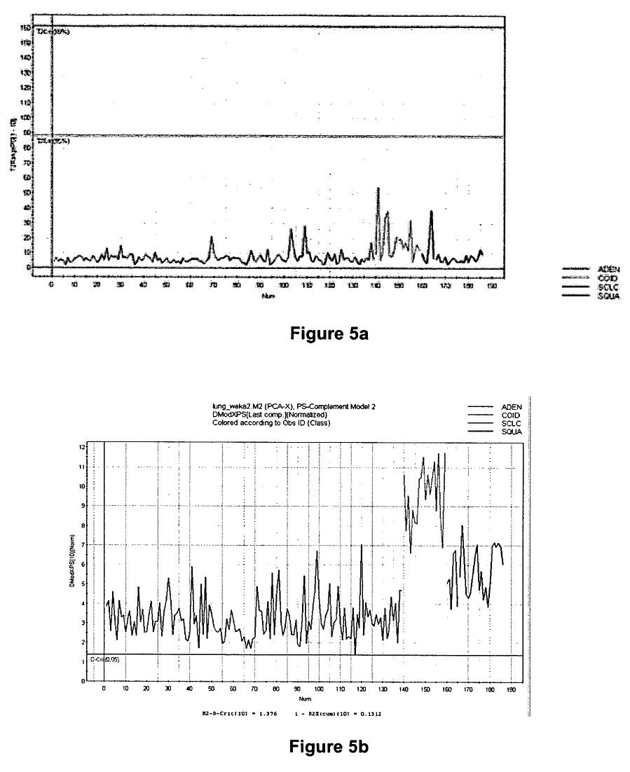

Referring now to FIG. 5a, there is shown a T² line plot of cancer subsets run against NORMAL model, according to an aspect of the present invention. As may be seen in FIG. 5a, another vector model was created, using only the NORMAL subset of the overall dataset modeled in FIG. 3a. Then the cancer subsets were run against that model. The output of this example might be used in many ways, including, but not limited to, diagnosis, prognosis, treatment course, and identifying promising future research areas. FIG. 5a shows that most of the cancer sample data points fit this new NORMAL vector model (created from the combination of the 12,600 variables) relatively well.

Referring now to FIG. 5b, there is shown a fit to model (SPE in this example), according to an aspect of the present invention. As may be seen in FIG. 5b, it may be seen that the fit to model limits has been exceeded. This implies that different relationships among the 12,600 genes are present in the NORMAL subset vs. the cancer subsets. Additionally, differences among the cancer subsets may also be present.

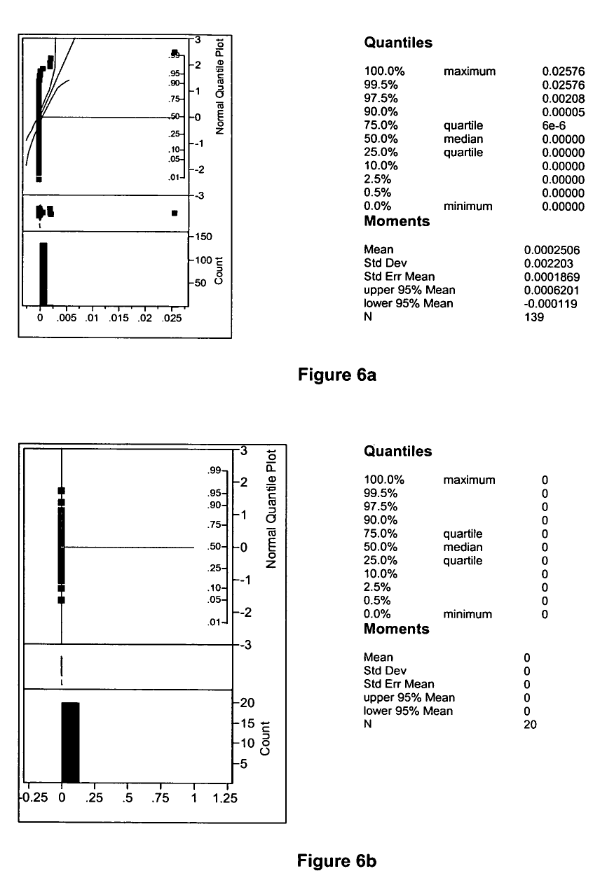

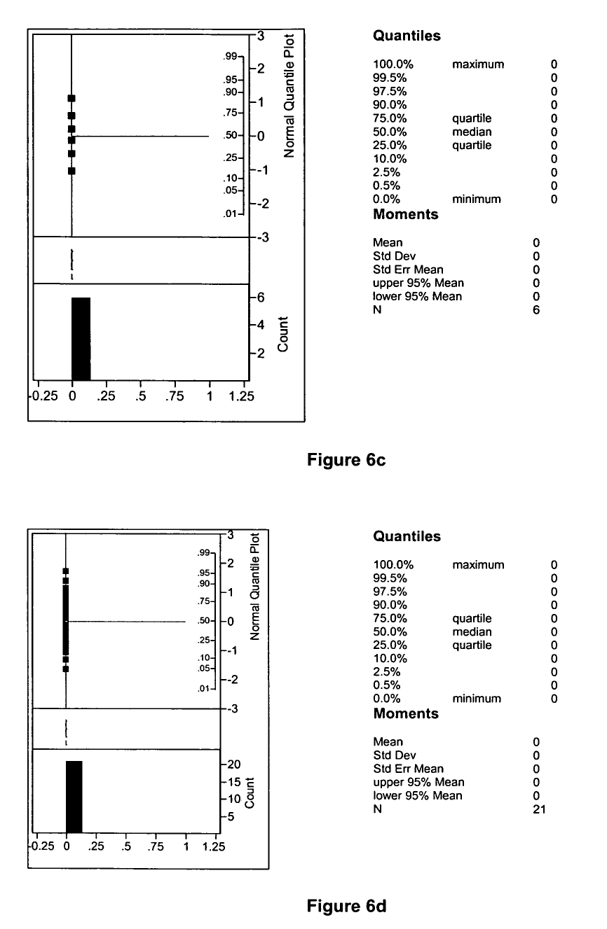

Referring now to FIGS. 6a, 6b, 6c, and 6d, there are shown class=ADEN, class=COID, class=SCLC, and class=SQUA membership probability distributions of cancer subset gene vectors belonging to normal subset, according to an aspect of the present invention. As may be seen in FIGS. 6a, 6b, 6c, and 6d, the NORMAL vector model shown in FIGS. 5a and 5b may be used to determine the probability that each of the cancer type samples belongs to the NORMAL subset. In FIG. 6a, the ADEN cancer sample set was run against the NORMAL model. In FIG. 6b, the COID cancer sample set was run against the NORMAL model. In FIG. 6c, the SCLC cancer sample set was run against the NORMAL model. In FIG. 6d, the SQUA cancer sample set was run against the NORMAL model. These analyses seem to indicate a clear delineation among the NORMAL and cancer groups, which may indicate that the NORMAL model is effective at predicting whether a new sample belongs to the NORMAL group (low probability of cancer) or one of the cancer groups (perhaps an additional medical procedure would then be recommended).

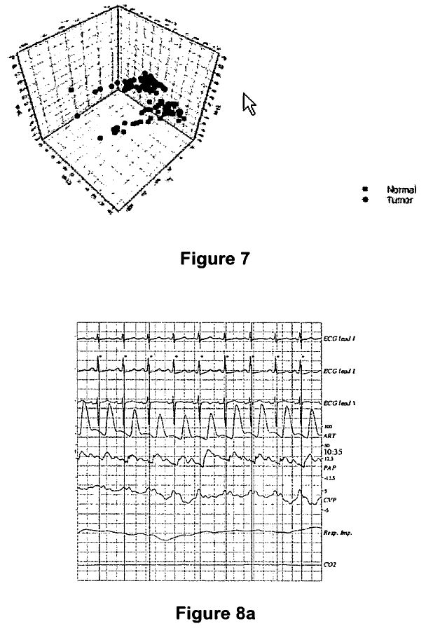

Referring now to FIG. 7, there is shown a vector machine algorithm 2 results for NORMAL vs. PROSTATE TUMOR classes, according to an aspect of the present invention. As may be seen in FIG. 7, the Master Algorithm Engine may take a large number of variables from a sample data set and perform a vector analysis to extract the most meaningful combination of variables to provide to a professional or control system 154. In this example, Prostate Cancer Data was taken from a publicly available reference (Dinesh Singh, et al. “Gene Expression Correlates of Clinical Prostate Cancer Behavior”. Cancer Cell, 1:203-209, March, 2002). From 102 specimens of prostate tumor samples and non-tumor prostate samples, 12,600 gene variables were input into a vector analysis. A new vector machine algorithm was used for this dataset, because the algorithm used in the lung cancer example did not reveal obvious distinctions between the prostate cancer and normal prostate subsets. A different vector analysis was performed to create a model to determine key combinations of variables, and the output of that analysis was used as input for a basic machine learning algorithm. Machine learning was used after that to cluster the variables into color groups. The output of this example might be used in many ways, including, but not limited to, diagnosis, prognosis, treatment course decisions, and determining which key gene interactions are present. FIG. 7 shows that the data can be separated using the three most meaningful combinations of the 12,600 variables; each of the two samples (tumor and normal) can be observed to take up a primarily different portion of three-dimensional space. This may demonstrate that some structure is present in the dataset.

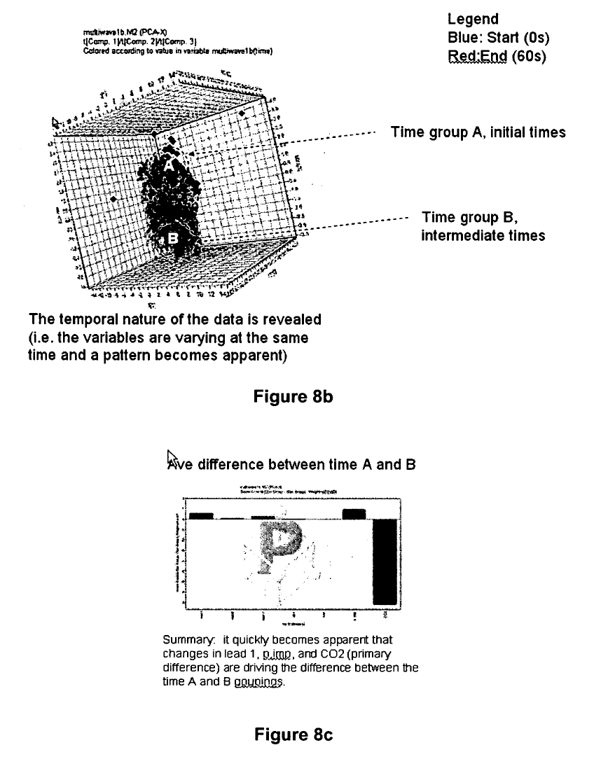

Referring now to FIG. 8a, there are shown example waveforms (temporally-paired waveforms), according to an aspect of the present invention. As may be seen in FIG. 8a, the Master Algorithm Engine may take a large number of variables from a waveform data set and perform a temporally-based vector analysis to extract the most meaningful combination of variables to provide to a professional or control system 154. In this example, waveform data was taken from a publicly available reference (Massachusetts General Hospital/Marquette Foundation (MGH/MF) Waveform Database). From waveform recordings of 250 patients, one-minute samples were taken, using the following variables: three ECG leads, arterial pressure, pulmonary arterial pressure, respiratory impedance, and airway CO2 waveforms. The original signals were recorded on 8-channel instrumentation tape and then digitized at twice real time. The raw sampling rate of 1440 samples per second per signal was reduced by a factor of two to yield an effective rate of 360 samples per second per signal relative to real time. This approach permitted the use of low-order analog anti-aliasing in combination with high-order digital FIR anti-aliasing to minimize phase distortion in the digitized signals. For this example, the data was analyzed using a temporally-based vector algorithm to determine important variable interactions as a function of time. The output of this example might be used in a variety of ways, including, but not limited to, routine medical treatment, emergency response vehicle treatment, diagnosis, prognosis, and treatment course decisions. FIG. 8a shows an example set of temporally-paired waveforms for a single patient sample, which includes the variables used in the vector algorithm (three ECG leads, arterial pressure, pulmonary arterial pressure, respiratory impedance, and airway CO2 waveforms). These waveforms may be tracked and trended over time by master algorithm engine 140, in order to determine which variables are driving changes in the waveforms. According to an aspect of the present invention, transformations of waveforms may be used, instead of, or in addition to, temporally-paired or other waveforms.

Referring now to FIG. 8b, there is shown temporal pattern co-evolution of: three ECG leads, arterial pressure, pulmonary arterial pressure, respiratory impedance, and airway CO2 waveforms, according to an aspect of the present invention. As may be seen in FIG. 8b, the data can be separated using the three most meaningful combinations of the waveform variables; the value of the variables over time can be observed to take up a primarily different portion of three-dimensional space (e.g., time groups A and B are separated in visual space). This example allows multiple inputs to be summarized and visualized in a single plot, with additional plots easily available for drill-down. The advantages this provides may include, but are not limited to, identification of changes in variables and variable interactions, ease of visualization, and ease of drill-down determination of key variables driving change.

Referring now to FIG. 8c, there is shown key variable contribution to temporal pattern change seen in FIG. 8b, according to an aspect of the present invention. As may be seen in FIG. 8c, the independent variables that are driving the difference between groups A and B are ECG lead 1, respiratory impedance, and airway CO2. This information may guide a doctor to monitor these outputs most carefully during patient treatment.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A medical data acquisition and analysis system, comprising:
a algorithm engine that receives a plurality of content, and that generates enhanced diagnosis content therefrom;
a plurality of inputs to said algorithm engine, wherein each of said plurality of inputs receives content from a respective one of a plurality of collaborators seeking to generate the enhanced diagnosis content;
at least one algorithm resident at said algorithm engine, wherein the enhanced diagnosis content is generated in accordance with said at least one algorithm;
at least one output from said algorithm engine, wherein the enhanced diagnosis content is output via said at least one output to enable a system user to provide enhanced diagnosis content.
